(19) United States
(12) Patent Application Publication
(10) Pub. No.: US 2026/0169167 A1
(43) Pub. Date: Jun. 18, 2026

(54) OBSTACLE DETECTION APPARATUS, OBSTACLE DETECTION METHOD, AND NON-TRANSITORY COMPUTER-READABLE MEDIUM

(71) Applicant: NEC CORPORATION, Minato-ku, Tokyo (JP)

(72) Inventor: Akira TSUJI, Tokyo (JP)

(73) Assignee: NEC CORPORATION, Minato-ku, Tokyo (JP)

(21) Appl. No.: 18/713,242

(22) PCT Filed: Nov. 29, 2021
(86) PCT No.: PCT/JP2021/043665

§ 371 Date: May 24, 2024

(51) Int. Cl. G01S 17/89; G06T 7/73; G06V 10/26; G06V 10/762; G06V 20/64

(52) U.S. Cl. CPC G01S 17/89; G06T 7/73; G06V 10/26; G06V 10/762; G06V 20/64; G06T 2207/10028

(57) ABSTRACT

An obstacle detection apparatus acquires a three-dimensional map representing a three-dimensional position of each of a plurality of points of a facility. The obstacle detection apparatus detects, from the three-dimensional map, a target surface for which determination of whether or not the target surface is an obstacle region is performed. The obstacle detection apparatus detects, as the obstacle region, the target surface that satisfies a predetermined obstacle condition among the detected target surfaces. The obstacle condition includes an essential condition satisfied in a case where an angle formed by the target surface and a horizontal plane is equal to or larger than a first threshold.

### TECHNICAL FIELD

The present disclosure relates to a technology for detecting an obstacle.

### BACKGROUND ART

A technology for detecting an obstacle has been developed. For example, Patent Literature 1 discloses a technology in which a self-propelled traveling device is moved in a residence to find an obstacle to walking in the residence, thereby allowing an administrator or the like to grasp each obstacle to walking in the residence.

### CITATION LIST

### Patent Literature

Patent Literature 1: Japanese Unexamined Patent Application Publication No. 2016-192040.

### SUMMARY OF INVENTION

### Technical Problem

In the invention of Patent Literature 1, whether or not an object is an obstacle is determined based on the position and size of the object. The present invention has been made in view of such a problem, and an object of the present invention is to provide a new technology for detecting an obstacle.

### Solution to Problem

An obstacle detection apparatus of the present disclosure includes an acquisition unit configured to acquire a three-dimensional map representing a three-dimensional position of each of a plurality of points of a facility; a surface detection unit configured to detect, from the three-dimensional map, a target surface for which determination of whether or not the target surface is an obstacle region is performed; and an obstacle detection unit configured to detect, among the detected target surfaces, the target surface that satisfies a predetermined obstacle condition as the obstacle region. The obstacle condition includes an essential condition satisfied in a case where an angle formed by the target surface and a horizontal plane is equal to or larger than a first threshold.

An obstacle detection method of the present disclosure is executed by a computer. The obstacle detection method includes an acquisition step of acquiring a three-dimensional map representing a three-dimensional position of each of a plurality of points of a facility; a surface detection step of detecting, from the three-dimensional map, a target surface for which determination of whether or not the target surface is an obstacle region is performed; and an obstacle detection step of detecting, among the detected target surfaces, the target surface that satisfies a predetermined obstacle condition as the obstacle region. The obstacle condition includes an essential condition satisfied in a case where an angle formed by the target surface and a horizontal plane is equal to or larger than a first threshold.

A computer-readable medium of the present disclosure stores a program causing a computer to execute the obstacle detection method of the present disclosure.

### Advantageous Effects of Invention

According to the present disclosure, a new technology for detecting an obstacle is provided.

### BRIEF DESCRIPTION OF DRAWINGS

FIG. 1 is a diagram illustrating an overview of an operation of an obstacle detection apparatus of a first example embodiment.

FIG. 2 is a block diagram illustrating a functional configuration of the obstacle detection apparatus of the first example embodiment.

FIG. 3 is a block diagram illustrating a hardware configuration of a computer that implements the obstacle detection apparatus.

FIG. 4 is a flowchart illustrating a flow of processes executed by the obstacle detection apparatus of the first example embodiment.

FIG. 5 is a block diagram illustrating a functional configuration of the obstacle detection apparatus of the first example embodiment including an output unit.

FIG. 6 is a diagram illustrating an overview of an operation of an obstacle detection apparatus of a second example embodiment.

FIG. 7 is a block diagram illustrating a functional configuration of the obstacle detection apparatus according to the second example embodiment.

FIG. 8 is a flowchart illustrating a flow of processes executed by the obstacle detection apparatus of the second example embodiment.

FIG. 9 is a first diagram illustrating a detection range.

FIG. 10 is a second diagram illustrating a detection range.

FIG. 11 is a third diagram illustrating a detection range.

FIG. 12 is a block diagram illustrating a functional configuration of the obstacle detection apparatus of the second example embodiment including an output unit.

FIG. 13 is a first diagram illustrating output information.

FIG. 14 is a second diagram illustrating output information.

### EXAMPLE EMBODIMENT

Hereinafter, an example embodiment of the present disclosure is described in detail with reference to the drawings. In the drawings, the same or corresponding elements are denoted by the same reference numerals, and repeated description is omitted as necessary for clarity of description. In addition, unless otherwise described, predetermined values such as predetermined values and thresholds are stored in advance in a storage device or the like accessible from a device using the values. Furthermore, unless otherwise described, a storage unit includes one or more storage devices of any number.

### First Example Embodiment

### <Overview>

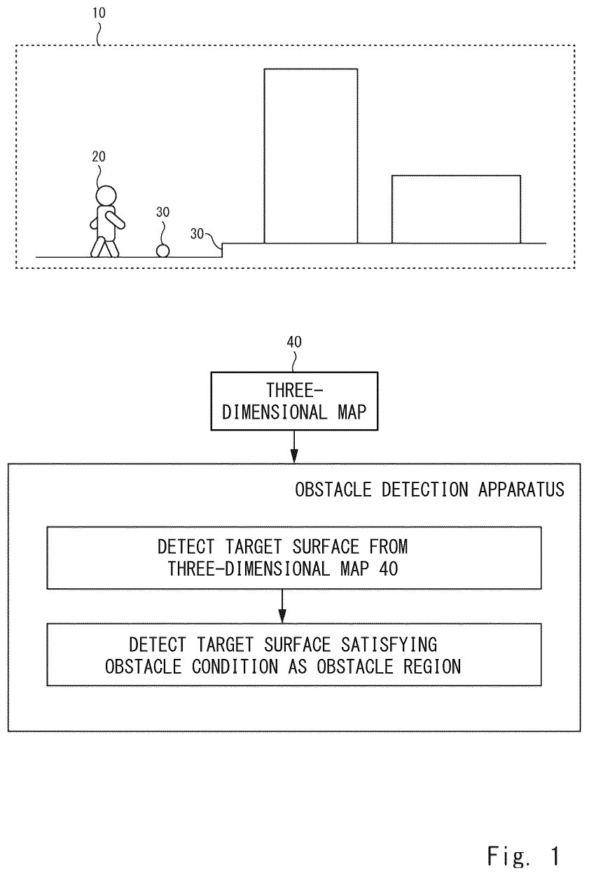

FIG. 1 is a diagram illustrating an overview of an operation of an obstacle detection apparatus 2000 of a first example embodiment. Here, FIG. 1 is a diagram for facilitating understanding of the overview of the obstacle detection apparatus 2000, and the operation of the obstacle detection apparatus 2000 is not limited to that illustrated in FIG. 1.

The obstacle detection apparatus 2000 detects an obstacle 30 that hinders movement of a user 20 in a facility 10. The facility 10 may be an outdoor facility or an indoor facility. The outdoor facility 10 is, for example, a substation. The indoor facility 10 is, for example, the inside of a factory. The user 20 is a person who uses the obstacle detection apparatus 2000 in the facility 10, and is, for example, a worker who performs work in the facility 10.

The obstacle detection apparatus 2000 detects the obstacle 30 by using a three-dimensional map 40 that is data representing a three-dimensional map of the facility 10. The three-dimensional map 40 represents a three-dimensional position (three-dimensional coordinates) of each of a plurality of points of the facility 10. The three-dimensional map 40 is implemented by, for example, point cloud data representing three-dimensional positions of the plurality of points of the facility 10. The point cloud data includes point data for each of the plurality of points. The point data indicates three-dimensional coordinates of a corresponding point. The point cloud data is obtained, for example, by scanning the plurality of points of the facility 10 using a light detection and ranging (LiDAR), a depth camera, or the like. However, as described below, the three-dimensional map 40 is not limited to the point cloud data.

The obstacle detection apparatus 2000 detects one or more target surfaces for which determination of whether or not the target surface is an obstacle region is performed, from the three-dimensional map 40. The obstacle region is a region representing a part of or the entire obstacle 30. Furthermore, the obstacle detection apparatus 2000 detects the target surface representing the obstacle region from among the detected target surfaces.

Here, the obstacle detection apparatus 2000 detects, as the obstacle region, the target surface that satisfies a predetermined obstacle condition among the target surfaces detected from the three-dimensional map 40. The obstacle condition is a condition satisfied in a case where the target surface is a region representing a part of or the entire obstacle 30 (that is, the obstacle region). The obstacle condition includes at least a condition (hereinafter, referred to as an essential condition) satisfied in a case where an angle formed by the target surface and a horizontal plane is equal to or larger than a predetermined threshold. The threshold is preferably a value close to 90 degrees (for example, a value between 60 degrees and 90 degrees).

### <Example of Advantageous Effect>

In a facility such as a substation or a factory, it is not preferable that a worker or the like is injured by stumbling over an obstacle, hitting an obstacle, or the like. For example, the number of such injuries can also be treated as an evaluation index of a company regarding job safety. In addition, human resources are reduced in a case where the worker cannot work for a while due to an injury. Therefore, it is important to prevent occurrence of an injury due to an obstacle.

Therefore, the obstacle detection apparatus 2000 detects the target surface from the three-dimensional map 40, and detects the obstacle region which is a surface satisfying the obstacle condition from among the detected target surfaces. As described above, the obstacle condition includes at least the essential condition that is satisfied in a case where the angle formed by the target surface and the horizontal plane is equal to or larger than the threshold.

Conceptually speaking, the essential condition is satisfied in a case where the target surface is not a lying surface but a surface standing to some extent. Such a standing surface is more likely to cause the user 20 to stumble and fall down on the surface or to hit and be injured on the surface than a lying surface. For example, in a case where there is a step at a movement destination of the user 20, the user 20 may stumble on the step and fall down. On the other hand, in a case where there is a gentle slope at the movement destination of the user 20, it can be said that a probability that the user 20 is injured on the slope is low.

According to the obstacle detection apparatus 2000, a new obstacle detection technology in which such a standing surface is detected as the obstacle region is provided. Furthermore, this enables the user 20 to easily grasp the presence of the obstacle 30 to be noted. Therefore, it is possible to prevent an injury caused by the obstacle 30 in the facility 10.

Hereinafter, the obstacle detection apparatus 2000 of the present example embodiment is described in more detail.

### <Example of Functional Configuration>

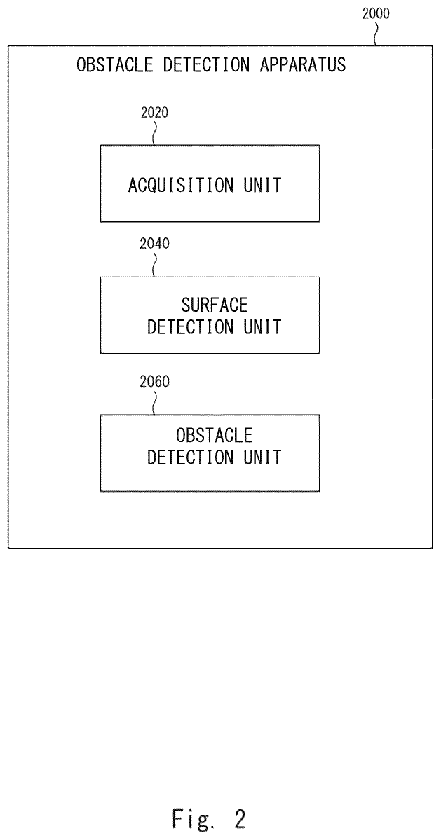

FIG. 2 is a block diagram illustrating a functional configuration of the obstacle detection apparatus 2000 of the first example embodiment. The obstacle detection apparatus 2000 includes an acquisition unit 2020, a surface detection unit 2040, and an obstacle detection unit 2060. The acquisition unit 2020 acquires the three-dimensional map 40. The surface detection unit 2040 detects the target surface from the three-dimensional map 40. The obstacle detection unit 2060 detects the target surface that satisfies the obstacle condition as the obstacle region.

### <Example of Hardware Configuration>

Each functional configuration unit of the obstacle detection apparatus 2000 may be implemented by hardware that implements each functional configuration unit (for example, a hard-wired electronic circuit) or may be implemented by a combination of hardware and software (for example, a combination of an electronic circuit and a program that controls the electronic circuit or the like). Hereinafter, a case where each functional configuration unit of the obstacle detection apparatus 2000 is implemented by a combination of hardware and software is further described.

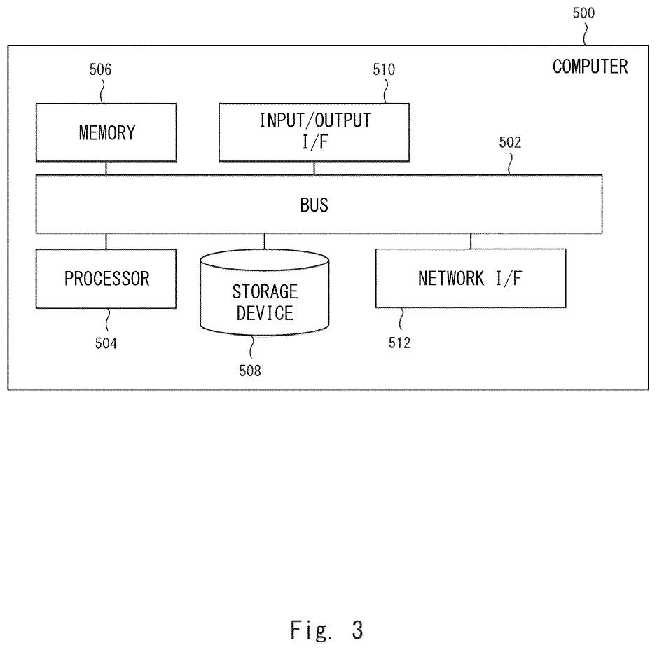

FIG. 3 is a block diagram illustrating a hardware configuration of a computer 500 that implements the obstacle detection apparatus 2000. The computer 500 is any computer. For example, the computer 500 is a stationary computer such as a personal computer (PC) or a server machine. In addition, for example, the computer 500 is a portable computer such as a smartphone or a tablet terminal. The portable computer is, for example, a user terminal possessed by the user 20. The computer 500 may be a dedicated computer designed to implement the obstacle detection apparatus 2000 or may be a general-purpose computer.

For example, by installing a predetermined application in the computer 500, each function of the obstacle detection apparatus 2000 is implemented by the computer 500. The above-described application is configured with a program for implementing the functional configuration units of the obstacle detection apparatus 2000. Note that a method of acquiring the program is arbitrary. For example, the program can be acquired from a storage medium (a DVD disk, a USB memory, or the like) in which the program is stored. In addition, for example, the program can be acquired by downloading the program from a server device that manages a storage device in which the program is stored.

The computer 500 includes a bus 502, a processor 504, a memory 506, a storage device 508, an input/output interface 510, and a network interface 512. The bus 502 is a data transmission path for the processor 504, the memory 506, the storage device 508, the input/output interface 510, and the network interface 512 to transmit and receive data to and from each other. However, a method of connecting the processor 504 and the like to each other is not limited to the bus connection.

The processor 504 is various processors such as a central processing unit (CPU), a graphics processing unit (GPU), or a field-programmable gate array (FPGA). The memory 506 is a main storage device implemented by using a random access memory (RAM) or the like. The storage device 508 is an auxiliary storage device implemented by using a hard disk, a solid state drive (SSD), a memory card, a read only memory (ROM), or the like.

The input/output interface 510 is an interface for connecting the computer 500 and an input/output device. For example, an input device such as a keyboard and an output device such as a display device are connected to the input/output interface 510.

The network interface 512 is an interface for connecting the computer 500 to a network. The network may be a local area network (LAN) or a wide area network (WAN).

The storage device 508 stores a program for implementing each functional configuration unit of the obstacle detection apparatus 2000 (a program for implementing the above-described application). The processor 504 reads the program to the memory 506 and executes the program to implement each functional configuration unit of the obstacle detection apparatus 2000.

The obstacle detection apparatus 2000 may be implemented by one computer 500 or may be implemented by the plurality of computers 500. In the latter case, the configurations of the computers 500 do not need to be the same, and can be different from each other.

### <Flow of Processes>

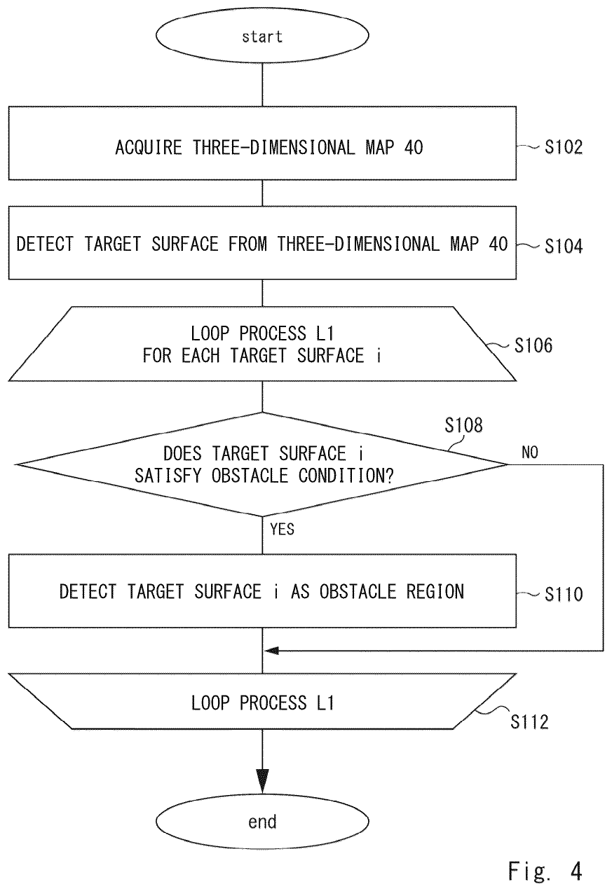

FIG. 4 is a flowchart illustrating a flow of processes executed by the obstacle detection apparatus 2000 of the first example embodiment. The flow of processes illustrated in FIG. 4 is an example, and the flow of processes executed by the obstacle detection apparatus 2000 is not limited to the flow illustrated in FIG. 4.

The acquisition unit 2020 acquires the three-dimensional map 40 (S102). The surface detection unit 2040 detects the target surface from the three-dimensional map 40 (S104). S106 to S112 constitute a loop process L1. The loop process L1 is executed for each target surface.

In S106, the obstacle detection apparatus 2000 determines whether or not the loop process L1 has been executed for all the target surfaces. In a case where the loop process L1 has already been executed for all the target surfaces, the processing of FIG. 4 ends. On the other hand, in a case where there is a target surface that is not yet subjected to the loop process L1, the obstacle detection apparatus 2000 selects one of them. The target surface selected here is referred to as a target surface i. After the target surface i is selected, S108 is executed.

The obstacle detection unit 2060 determines whether or not the target surface i satisfies the obstacle condition (S108). In a case where the target surface i satisfies the obstacle condition (S108: YES), the obstacle detection unit 2060 detects the target surface i as the obstacle region (S110). Since S112 is the end of the loop process L1, S106 is executed next.

### <Three-Dimensional Map 40>

The three-dimensional map 40 is generated by measuring the three-dimensional position of each of the plurality of points of the facility 10 using various sensors. The sensor used for generating the three-dimensional map 40 is, for example, a distance measurement apparatus capable of measuring a distance between the sensor and a measurement target. The distance measurement apparatus measures a three-dimensional position of each of a plurality of points in a real space using, for example, electromagnetic waves such as laser light. Specifically, the distance measurement apparatus emits electromagnetic waves in a plurality of different directions and receives reflected waves which are the electromagnetic waves reflected by an object for respective electromagnetic waves. Then, the distance measurement apparatus generates point data representing a three-dimensional position of a point where the electromagnetic waves are reflected from a relationship between the emitted electromagnetic waves and the reflected waves thereof. Point cloud data is generated as a set of point data obtained for each of the plurality of points of the facility 10. Examples of such a distance measurement apparatus include a light detection and ranging (LiDAR) and a depth camera.

The sensor is not limited to the distance measurement apparatus. For example, a camera that generates a two-dimensional captured image may be used as the sensor. In this case, for example, by applying structure from motion (SFM) to a plurality of captured images including the facility 10, the three-dimensional coordinates of each of the plurality of points of the facility 10 are determined, and the three-dimensional map 40 including a set of point data indicating the determined three-dimensional coordinates is generated. In this case, the plurality of captured images is obtained by capturing the facility 10 from different directions. An existing technology can be used as a technology for generating three-dimensional data of a captured object using the SFM.

The three-dimensional map 40 only needs to include data (point data) indicating the three-dimensional position of each of the plurality of points of the facility 10, and is not limited to the point cloud data described above. For example, the three-dimensional map 40 may include mesh data, surface data, and the like.

The sensor may be used in a state of being fixed at a specific position, or may be used while moving. In the former case, for example, measurement is performed using the sensor fixed using a tripod or the like. In addition, for example, the worker may stay at a specific position in a state of holding or wearing the sensor, and perform measurement by using the sensor. Thereafter, in a case where it is desired to perform measurement at another position, the same operation is performed at the another position. As a result, measurement can be performed at each of the plurality of points of the facility 10.

In a case where the sensor is used while moving, for example, the worker moves in a state of holding or wearing the sensor in the facility 10 to measure the facility 10. In this case, the sensor is provided in a smartphone held by the worker, a wearable device worn by the worker, or the like. In addition, for example, the measurement of the facility 10 may be performed by causing a moving object (for example, a flying or traveling robot), to which the sensor is attached, to move in the facility 10. By causing the sensor to repeatedly perform the measurement in such a moving state, the measurement can be performed at each of the plurality of points of the facility 10.

A plurality of measurements may be performed not only by changing the position of the sensor but also by changing the measurement direction at the same position.

In a case where the measurement is performed at a plurality of positions or from measurement directions, the three-dimensional map 40 is generated by integrating measurement results obtained by the respective measurements. An existing technology can be used as a technology for integrating measurement results obtained at a plurality of positions or from measurement directions to generate one piece of three-dimensional data.

Here, the three-dimensional map 40 may be data representing the measurement result of the distance measurement apparatus or the result of the SFM as it is, or may be data obtained by performing predetermined processing on these pieces of data. Examples of the predetermined processing include processing of applying coordinate transformation to each point data in such a way that the position of a specific point in a real space becomes the origin of the coordinate space of the three-dimensional map 40 or downsampling processing of omitting point data at predetermined distance intervals to achieve size reduction.

Here, the three-dimensional map 40 may reflect a result of measurement performed in real time (a timing when the obstacle detection apparatus 2000 is used). For example, it is assumed that the user 20 of the obstacle detection apparatus 2000 moves in the facility 10 while performing measurement with a sensor. In this case, a result of the measurement is reflected in the three-dimensional map 40 as needed. Hereinafter, an apparatus that updates the three-dimensional map 40 is referred to as a map update apparatus. For example, the map update apparatus is implemented by the obstacle detection apparatus 2000, a user terminal possessed by the user 20 of the obstacle detection apparatus 2000, an arbitrary server device, or the like.

The map update apparatus detects three-dimensional data not included in the three-dimensional map 40 by comparing the three-dimensional data obtained by the measurement performed in real time with the three-dimensional map 40. For example, three-dimensional data representing an object temporarily placed in the facility 10 or an object newly installed in the facility 10 after the three-dimensional map 40 is generated is detected as the three-dimensional data not included in the three-dimensional map 40. The map update apparatus updates the three-dimensional map 40 in such a way as to include the three-dimensional data detected in this manner.

### <Acquisition of Three-Dimensional Map 40: S102>

The acquisition unit 2020 acquires the three-dimensional map 40 (S102). There are various methods for the acquisition unit 2020 to acquire the three-dimensional map 40. For example, the three-dimensional map 40 is stored in advance in a storage unit accessible from the obstacle detection apparatus 2000. The acquisition unit 2020 acquires the three-dimensional map 40 by accessing the storage unit.

In addition, for example, the three-dimensional map 40 may be input to the obstacle detection apparatus 2000 in response to a user operation. For example, the user 20 connects a portable storage unit (such as a memory card) in which the three-dimensional map 40 is stored to the obstacle detection apparatus 2000, and inputs the three-dimensional map 40 from the storage unit to the obstacle detection apparatus 2000.

Alternatively, for example, the acquisition unit 2020 may acquire the three-dimensional map 40 by receiving the three-dimensional map 40 transmitted from another apparatus. For example, the another apparatus is an apparatus that generates the three-dimensional map 40.

### <Detection of Target Surface: S104>

The surface detection unit 2040 detects the target surface from the three-dimensional map 40 (S104). Hereinafter, a target surface detection method will be described.

For example, the surface detection unit 2040 clusters each piece of point data shown on the three-dimensional map 40 into sets of point data representing the same plane. Then, the surface detection unit 2040 treats a surface represented by each cluster as the target surface. That is, a plurality of pieces of point data included in one cluster is treated as a group of point data constituting one target surface.

There are various methods for clustering point data for each same surface. For example, the surface detection unit 2040 calculates a normal vector of each point data included in the three-dimensional map 40. Here, the normal vector of the point data can be calculated as, for example, a normal vector of a triangular surface including the point data and other two pieces of point data close to the point data. In a case where the three-dimensional map 40 is mesh data, the normal vector of the point data can be calculated as a normal vector of any one surface including the point data.

The surface detection unit 2040 clusters point data based on a direction of the normal vector. Specifically, in a case where a difference between a direction of a normal vector of a certain piece of point data and a direction of a normal vector of another piece of point data close to the point data (for example, a distance therebetween is equal to or less than a predetermined threshold) is small (for example, the difference is equal to or less than a predetermined threshold), the surface detection unit 2040 puts these pieces of point data into the same cluster. With this processing, a plurality of adjacent small surfaces having close directions can be regarded as one large surface.

Here, in the three-dimensional map 40, there may be an object having a curved surface, such as a pipe or a tank. Therefore, for example, the surface detection unit 2040 may detect a cylindrical region by performing cylindrical fitting, and treat a side surface of the cylindrical region as the target surface. Here, the cylindrical fitting can be implemented using an algorithm such as RANSAC.

In a case of performing the cylindrical fitting, the surface detection unit 2040 detects a region that is highly likely to have a cylindrical shape from the three-dimensional map 40, and performs the cylindrical fitting on the region. This can be achieved, for example, by utilizing semantic segmentation. Specifically, the surface detection unit 2040 performs the semantic segmentation on point data included in the three-dimensional map 40, thereby clustering these pieces of point data for each point data representing the same object. As a result, the pieces of point data are divided into clusters for each point data representing the same object. In addition, the type (a wall, a tank, a pipe, an iron structure, or the like) of the object represented by each cluster is determined.

Furthermore, the surface detection unit 2040 performs the cylindrical fitting on point data included in each cluster of the type (a tank, a pipe, or the like) to be subjected to the cylindrical fitting, thereby specifying the target surface corresponding to the cluster. A type to be subjected to the cylindrical fitting is determined in advance.

The surface detection unit 2040 may use both a method of clustering the point data based on the normal vector and a method using the cylindrical fitting. In this case, for example, the surface detection unit 2040 first determines a region to be subjected to the cylindrical fitting, and performs the cylindrical fitting on the region to detect the side surface of the cylindrical region as the target surface. Thereafter, the surface detection unit 2040 detects the remaining target surface by performing clustering using the normal vector on each point data not included in the cylindrical region among the pieces of point data included in the three-dimensional map 40.

In addition, for example, the surface detection unit 2040 may divide the pieces of point data into clusters for each same object by the semantic segmentation, and then detect the target surface for each object. In this case, first, the surface detection unit 2040 applies the semantic segmentation to the pieces of point data included in the three-dimensional map 40 to divide the pieces of point data into clusters for each point data representing the same object. Next, the surface detection unit 2040 performs detection of the target surface using the cylindrical fitting for a cluster of an object of the type to be subjected to the cylindrical fitting. Furthermore, for clusters of other types of objects, the surface detection unit 2040 performs clustering using the normal vector described above on a plurality of pieces of point data included in the same cluster. As a result, a plurality of target surfaces is detected from the cluster of the same object.

In addition, for example, in a case where the three-dimensional map 40 includes point cloud data, the surface detection unit 2040 may detect the target surface by converting the point cloud data into mesh data. As a result, data representing a plurality of surfaces is obtained from the point cloud data. Therefore, for example, the surface detection unit 2040 treats each surface obtained by meshing as the target surface. However, the surface detection unit 2040 may downsample the point cloud data and then convert the downsampled point cloud data into mesh data in order to treat a surface having a certain size as the target surface.

In the above description, the target surface is detected using each point data included in the three-dimensional map 40. That is, the target surface is detected for the entire region represented by the three-dimensional map 40. However, the surface detection unit 2040 may detect the target surface for a partial region in the three-dimensional map 40 (in other words, by using some pieces of point data included in the three-dimensional map 40). The partial region may be designated by the user 20 or may be determined by the obstacle detection apparatus 2000. An example of a case where a detection range for the target surface is determined by the obstacle detection apparatus 2000 is described in a second example embodiment described below.

In addition, in a case where measurement is performed in real time for the facility 10, as described above, three-dimensional data not included in the three-dimensional map 40 may be obtained. The surface detection unit 2040 may further detect the target surface from the three-dimensional data obtained in this manner.

For example, the surface detection unit 2040 obtains a difference between three-dimensional data obtained by measurement performed in real time and the three-dimensional map 40, thereby determining three-dimensional data representing an object not shown on the three-dimensional map 40. As described above, among pieces of three-dimensional data obtained by real-time measurement, three-dimensional data representing an object not shown on the three-dimensional map 40 is referred to as temporary three-dimensional data. The temporary three-dimensional data is, for example, three-dimensional data representing an object such as equipment or a cable temporarily placed in the facility 10. The surface detection unit 2040 detects the target surface from the temporary three-dimensional data by a method similar to the method of detecting the target surface from the three-dimensional map 40 described above.

It is preferable that the obstacle region detected from the three-dimensional map 40 and the obstacle region detected from the temporary three-dimensional data can be distinguished from each other. Therefore, for example, as described below, in a case where information regarding the obstacle region is output, the information indicates from which of the three-dimensional map 40 and the temporary three-dimensional data each obstacle region has been detected.

### <Detection of Obstacle Region: S108 and S110>

The obstacle detection unit 2060 detects the target surface that satisfies the obstacle condition as the obstacle region (S108 and S110). As described above, the obstacle condition includes at least the essential condition that is satisfied in a case where the angle between the target surface and the horizontal plane is equal to or larger than the threshold.

The angle formed by the target surface and the horizontal plane can be grasped using, for example, a normal vector of the target surface. Specifically, the closer the direction of the normal vector of the target surface is to the horizontal direction, the larger the angle formed by the target surface and the horizontal plane.

Therefore, for example, the obstacle detection unit 2060 may use a condition that “an angle formed by a normal direction of the target surface and the horizontal direction is equal to or smaller than a threshold” as a specific essential condition. The threshold is preferably set to a value close to 0 degrees (for example, a value between 0 degrees and 30 degrees). In this case, the obstacle detection unit 2060 calculates the normal vector of the target surface, and calculates an angle formed by the calculated normal vector and the horizontal direction. The obstacle detection unit 2060 determines whether or not the calculated angle is equal to or smaller than the threshold. The target surface having the calculated angle equal to or smaller than the threshold is the target surface satisfying the essential condition. Here, an existing method can be used as a method for calculating a normal vector of a surface.

As in a case where the side surface of the cylindrical region is the target surface, the target surface may be a curved surface. In this case, in order to determine whether or not the essential condition is satisfied, a normal line in a direction closest to the horizontal direction among normal lines of the target surface is used. That is, it is determined that the essential condition is satisfied in a case where an angle formed by the direction of the normal line in the direction closest to the horizontal direction and the horizontal direction is equal to or less than a threshold.

The obstacle condition may further include a condition other than the above-described essential condition. Hereinafter, among the conditions included in the obstacle condition, a condition other than the essential condition is referred to as an additional condition.

For example, the additional condition is determined in such a way that a target surface having a relatively small height from a floor surface is detected as the obstacle region. It is considered that an object having a small height from the floor surface is less likely to be included in the field of view of the user 20, and is likely to cause falling.

Therefore, for example, a condition that “the height of the target surface from the floor surface is equal to or less than a threshold” is determined as the additional condition. In this case, the obstacle detection unit 2060 determines whether or not both the essential condition that “the angle formed by the target surface and the horizontal plane is equal to or larger than the threshold” and the additional condition that “the height of the target surface from the floor surface is equal to or smaller than the threshold” are satisfied for each target surface. Then, it is determined that the obstacle condition is satisfied for the target surface satisfying both of the conditions. On the other hand, it is determined that the obstacle condition is not satisfied for the target surface for which one or both of the essential condition and the additional condition are not satisfied.

Here, the floor surface means a floor surface on which an object including the target surface is located. In the facility 10, there may be a plurality of floors, or scaffoldings may be provided in various places. In such a case, the “height of the target surface from the floor surface” is the height of the floor or scaffolding on which the object including the target surface is placed from the floor surface.

Therefore, for example, the obstacle detection unit 2060 first determines the floor surface on which the object including the target surface is located by using the three-dimensional map 40. Then, the obstacle detection unit 2060 calculates, as the height of the target surface from the floor surface, a value obtained by subtracting a z coordinate of the floor surface from the maximum z coordinate among z coordinates of points included in the target surface. However, a method for calculating the height of the target surface from the floor surface is not limited thereto.

As the additional condition, for example, a condition of “being located at a place where the height from the floor surface is equal to or less than a threshold” can be used. For example, it is considered that a probability that the user 20 collides with an object installed at a position higher than the floor surface by 2 m or more is low. Therefore, the target surface present at a high position where the user 20 is unlikely to collide is not treated as the obstacle region.

The obstacle condition may include a plurality of additional conditions. In this case, the target surface satisfying the essential condition and all the additional conditions is detected as the obstacle region.

### <Output of Detection Result>

When the obstacle region is detected, the obstacle detection apparatus 2000 preferably outputs information regarding the detected obstacle region. The information output here is referred to as output information. Hereinafter, a functional configuration unit that outputs the output information is referred to as an output unit.

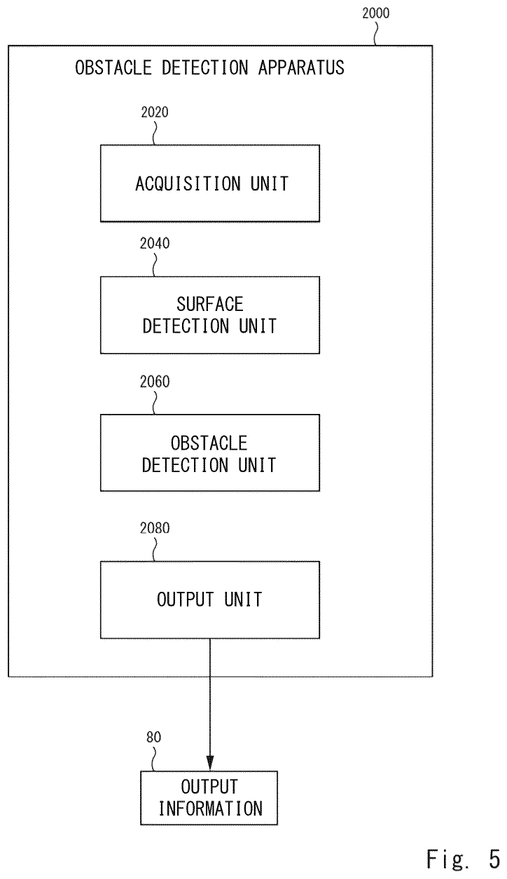

FIG. 5 is a block diagram illustrating a functional configuration of the obstacle detection apparatus 2000 including an output unit. An output unit 2080 outputs output information 80. An output destination of the output information 80 is, for example, a user terminal used by the user 20. By outputting the output information 80 to the user terminal, the user 20 can easily grasp the presence of the obstacle 30. Therefore, for example, in a case where the user 20 moves in the facility 10, the safety when the user 20 uses the facility 10 is improved. The output destination of the output information 80 is arbitrary and is not limited to the user terminal.

The output information 80 indicates various information. For example, the output information 80 indicates the type (a step, a device, a desk, a cable, or the like), size, position, or the like of the obstacle 30 indicated by the obstacle region. In addition, as described above, in a case where the obstacle region is detected also from the temporary three-dimensional data, the output information 80 may indicate, for each obstacle region, from which of the three-dimensional map 40 and the temporary three-dimensional data the obstacle region has been detected.

There are various manners of outputting the output information 80. For example, the output unit 2080 transmits the output information 80 to an arbitrary apparatus such as the user terminal. In addition, for example, the output unit 2080 may store the output information 80 in an arbitrary storage unit. In addition, for example, the output unit 2080 may cause an arbitrary display device the output information 80.

### Second Example Embodiment

### <Overview>

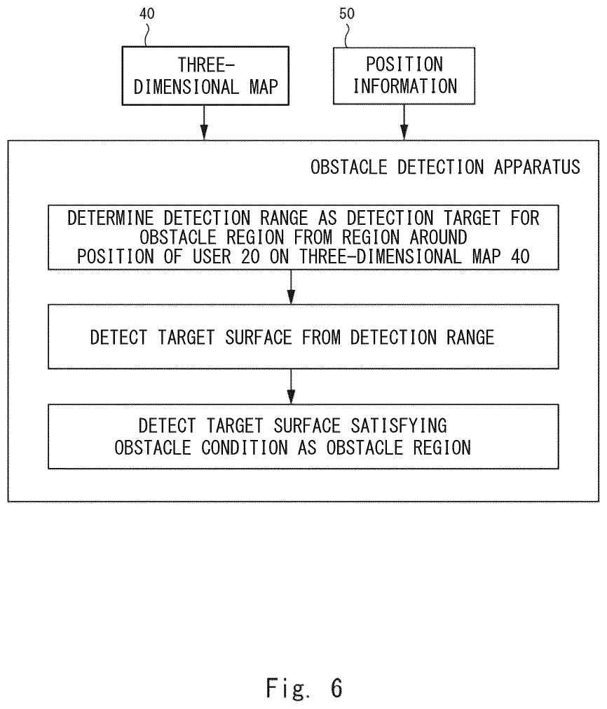

FIG. 6 is a diagram illustrating an overview of an operation of an obstacle detection apparatus 2000 of the second example embodiment. Here, FIG. 6 is a diagram for facilitating understanding of the overview of the obstacle detection apparatus 2000, and the operation of the obstacle detection apparatus 2000 is not limited to that illustrated in FIG. 6.

The obstacle detection apparatus 2000 of the second example embodiment detects an obstacle region from a predetermined range around a user 20 in a situation where the user 20 moves in a facility 10. The predetermined range as a detection target for the obstacle region is referred to as a detection range.

More specifically, the obstacle detection apparatus 2000 acquires position information 50 indicating the position of the user 20. For example, the position information 50 indicates the position of a user terminal possessed by the user 20. The user terminal is, for example, a smartphone, a tablet terminal, a wearable terminal (an eyeglass-type terminal, a watch-type terminal, or the like), or the like. However, the position indicated by the position information 50 is not limited to the position of the user terminal as described below.

The obstacle detection apparatus 2000 determines the detection range based on the position of the user 20 indicated by the position information 50. Further, the obstacle detection apparatus 2000 detects a target surface from the detection range. Then, the obstacle detection apparatus 2000 detects the target surface that satisfies an obstacle condition as the obstacle region.

### <Example of Advantageous Effect>

The obstacle detection apparatus 2000 of the second example embodiment detects the obstacle region present in the detection range around the user 20 (such as a worker who performs work in the facility 10) by using a three-dimensional map 40 and the position information 50. In this way, the user 20 can easily grasp the obstacle 30 present around the user oneself. Therefore, it is possible to prevent an injury caused by the obstacle 30 in the facility 10.

Hereinafter, the obstacle detection apparatus 2000 of the present example embodiment is described in more detail.

### <Example of Functional Configuration>

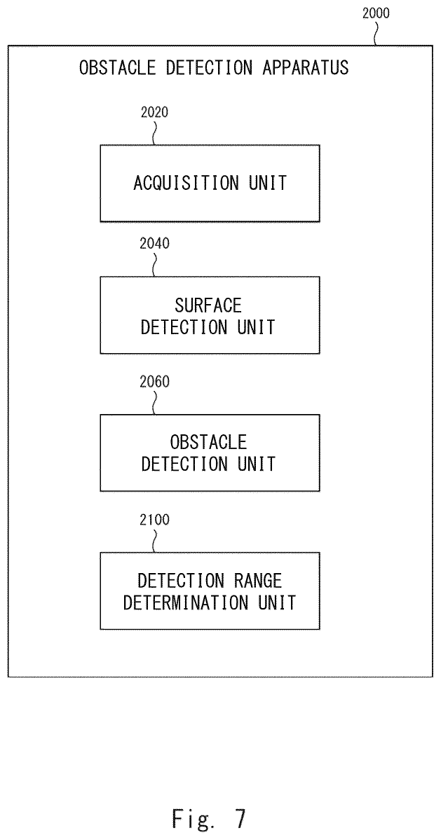

FIG. 7 is a block diagram illustrating a functional configuration of the obstacle detection apparatus 2000 of the second example embodiment. An acquisition unit 2020 of the second example embodiment further acquires the position information 50. The obstacle detection apparatus 2000 of the second example embodiment further includes a detection range determination unit 2100. The detection range determination unit 2100 determines the detection range by using the three-dimensional map 40 and the position information 50. A surface detection unit 2040 of the second example embodiment detects the target surface from the detection range.

### <Example of Hardware Configuration>

A hardware configuration of the obstacle detection apparatus 2000 of the second example embodiment is similar to the hardware configuration of the obstacle detection apparatus 2000 of the first example embodiment, and is illustrated in FIG. 3, for example. However, a storage device 508 of the second example embodiment stores a program for implementing each function of the obstacle detection apparatus 2000 of the second example embodiment.

### <Flow of Processes>

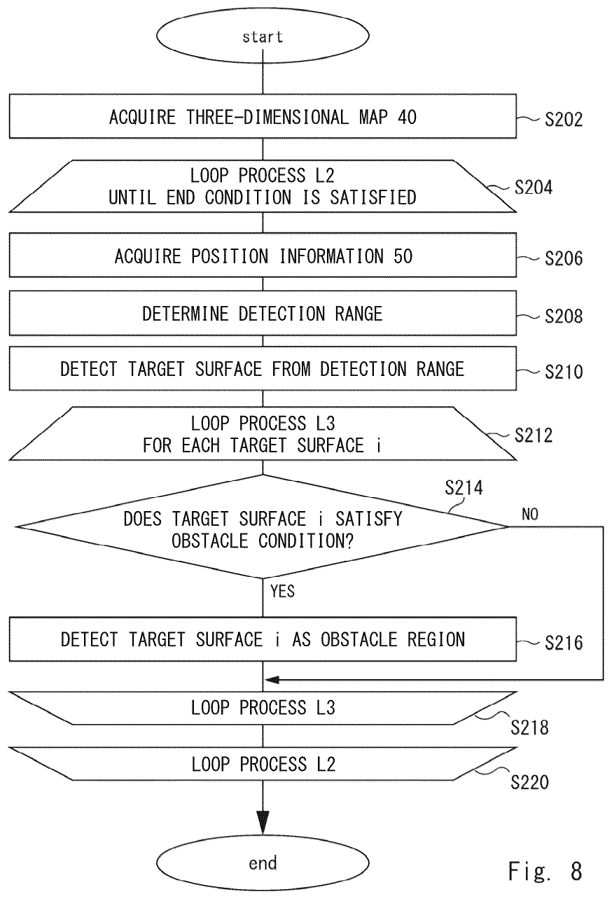

FIG. 8 is a flowchart illustrating a flow of processes executed by the obstacle detection apparatus 2000 of the second example embodiment. The flow of processes illustrated in FIG. 8 is an example, and the flow of processes executed by the obstacle detection apparatus 2000 is not limited to the flow illustrated in FIG. 8.

The acquisition unit 2020 acquires the three-dimensional map 40 (S202). S204 to S220 constitute a loop process L2. The loop processing L2 is repeatedly executed until a predetermined end condition is satisfied.

In S204, the obstacle detection apparatus 2000 determines whether or not the end condition is satisfied. In a case where the end condition is satisfied, the processing of FIG. 8 ends. On the other hand, in a case where the end condition is not satisfied, next, S206 is executed.

The acquisition unit 2020 acquires the position information 50 (S206). The detection range determination unit 2100 determines the detection range by using the three-dimensional map 40 and the position information 50 (S208). The surface detection unit 2040 detects the target surface from the detection range (S210).

S212 to S218 constitute a loop process L3. The loop process L3 is executed for each target surface. In S212, the obstacle detection apparatus 2000 determines whether or not the loop process L3 has been executed for all the target surfaces. In a case where the loop process L3 has already been executed for all the target surfaces, S220 is executed next. Since S220 is the end of the loop process L2, S204 is executed next.

On the other hand, in a case where there is a target surface that is not yet subjected to the loop process L3, the obstacle detection apparatus 2000 selects one of them. The target surface selected here is referred to as a target surface i. After the target surface i is selected, S214 is executed.

The obstacle detection unit 2060 determines whether or not the target surface i satisfies the obstacle condition (S214). In a case where the target surface i satisfies the obstacle condition (S214: YES), the obstacle detection unit 2060 detects the target surface i as the obstacle region (S216). Since S218 is the end of the loop process L3, S212 is executed next.

As described above, by repeatedly performing a process of “acquiring the position information 50 and detecting the obstacle region from the detection range determined based on the acquired position information 50”, it is possible to grasp whether or not the obstacle 30 is present around the user 20 after the movement according to the movement of the user 20.

Here, various conditions can be adopted as the end condition of the loop process L2. For example, the end condition is a condition that “a predetermined input operation is performed”. Alternatively, for example, the end condition is a condition that “the user 20 goes out of a range shown on the three-dimensional map 40”. For example, in a case where the three-dimensional map 40 represents the entire facility 10, the end condition is satisfied when the user 20 goes out of the facility 10.

### <Position Information 50>

The position information 50 is information indicating the position of the user 20. Here, various information can be adopted as the information indicating the position of the user 20. For example, the position information 50 indicates the position of the user terminal of the user 20. Here, various existing technologies can be used as a technology for determining the position of a specific terminal in a specific place (here, in the facility 10). For example, the position of the user terminal can be determined by detecting the position of a position sensor such as a global positioning system (GPS) sensor provided in the user terminal. In addition, for example, the position of the user terminal may be determined based on communication between a beacon or an RFID sensor provided in the facility 10 and the user terminal.

In addition, for example, the position of the user terminal may be determined using measurement data obtained from a sensor provided in the user terminal. The measurement data used to determine the position of the user terminal is, for example, a two-dimensional captured image obtained from a two-dimensional camera or three-dimensional data obtained from a depth camera, a LiDAR, or the like. An existing technology can be used as a technology for determining a position where the measurement is performed from these pieces of measurement data.

In a case where a captured image is used as the measurement data, for example, a captured image obtained by capturing at a corresponding position from a corresponding capturing direction is prepared in advance as a reference image for each of various combinations of the position and the capturing direction of the facility 10. Then, a position corresponding to the reference image matching the captured image obtained from the user terminal can be determined as the position of the user 20 by determining a reference image that matches the captured image among the reference images.

In a case where three-dimensional data is used as the measurement data, for example, three-dimensional data matching the three-dimensional data obtained from the user terminal is detected from the three-dimensional map 40. The three-dimensional data detected in this manner represents the three-dimensional region measured by the sensor. In addition, the measurement direction can be determined based on the measurement data. Then, the position of the sensor (that is, the position of the user terminal) can be determined based on the measured three-dimensional region and the measurement direction.

In addition, for example, a function of self-position estimation adopted in an autonomous mobile robot may be provided in the user terminal, and the position of the user terminal may be determined by the self-position estimation.

The user terminal does not have to be used to determine the position of the user 20. For example, the position of the user 20 may be determined by detecting the user 20 using a monitoring sensor (a camera or the like) provided in the facility 10.

The generation of the position information 50 may be performed by the obstacle detection apparatus 2000 or may be performed by an apparatus (such as a user terminal or a server device) other than the obstacle detection apparatus 2000. The apparatus that generates the position information 50 acquires information (for example, the measurement data) necessary for determining the position of the user 20, and determines the position of the user 20 by using the acquired information, thereby generating the position information 50.

### <Acquisition of Position Information 50: S206>

The acquisition unit 2020 acquires the position information 50 (S206). A method for acquiring the position information 50 is arbitrary. For example, the acquisition unit 2020 acquires the position information 50 by receiving the position information 50 transmitted from an apparatus that has generated the position information 50. In addition, for example, the acquisition unit 2020 may acquire the position information 50 by accessing a storage unit in which the position information 50 is stored.

### <Determination of Detection Range: S208>

The detection range determination unit 2100 determines the detection range by using the three-dimensional map 40 and the position information 50 (S208). For this purpose, first, the detection range determination unit 2100 determines the position of the user 20 on the three-dimensional map 40 (a position on three-dimensional map 40 that corresponds to the position of the user 20 represented by the position information 50). Here, it is assumed that the coordinate system of the three-dimensional map 40 and the coordinate system of the coordinates of the user 20 indicated by the position information 50 are different from each other. In this case, the detection range determination unit 2100 determines the position of the user 20 on the three-dimensional map 40 by converting the coordinates of the user 20 indicated by the position information 50 into coordinates on the coordinate system of the three-dimensional map 40. A relationship between the coordinate system of the three-dimensional map 40 and the coordinate system of the coordinates of the user 20 indicated by the position information 50 is defined in advance.

Here, an existing method can be used as a method for converting coordinates on a certain coordinate system into coordinates on another coordinate system. For example, a transformation matrix for performing coordinate transformation from the coordinate system of the coordinates of the user 20 indicated by the position information 50 to the coordinate system of the three-dimensional map 40 is defined in advance. In this case, the detection range determination unit 2100 calculates the coordinates representing the position of the user 20 on the three-dimensional map 40 by applying the transformation matrix to the coordinates of the user 20 indicated by the position information 50.

On the other hand, it is assumed that the coordinate system of the three-dimensional map 40 and the coordinate system of the coordinates of the user 20 indicated by the position information 50 are the same as each other. In this case, the position of the user 20 on the three-dimensional map 40 is represented by the coordinates of the user 20 indicated by the position information 50. Therefore, the detection range determination unit 2100 can use the position of the user 20 indicated by the position information 50 as it is as the position of the user 20 on the three-dimensional map 40.

After the position of the user 20 on the three-dimensional map 40 is determined, the detection range determination unit 2100 determines the detection range on the three-dimensional map 40 based on the position of the user 20 on the three-dimensional map 40. The detection range is a range around the user 20, and is a range as a detection target for the obstacle region.

There are various methods for determining the detection range. For example, the detection range determination unit 2100 determines, as the detection range, a range having a predetermined shape and a predetermined size and centered on the position of the user 20. The detection range is determined as, for example, a range on a two-dimensional plane in plan view of the three-dimensional map 40. The plan view here may be a view in which the three-dimensional map 40 is viewed from above in a vertical direction, or may be a view in which a floor surface on which the user 20 is located is viewed in a direction opposite to a normal vector thereof. The floor surface here also includes the ground. That is, in a case where the facility 10 is an outdoor facility, the floor surface on which the user 20 is located means the ground on which the user 20 is located.

The shape of the detection range can be any shape such as a circle or a rectangle. The shape of the detection range may be fixed in advance or may be changeable by an input operation. Similarly, the size of the detection range may be fixed in advance or may be changeable by an input operation.

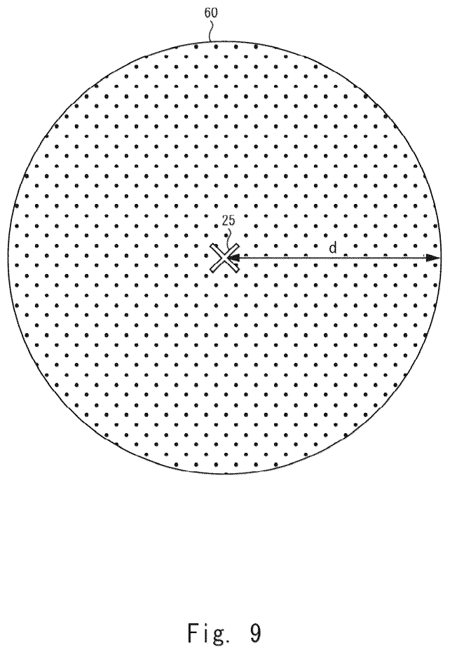

FIG. 9 is a first diagram illustrating the detection range. A detection range 60 is a range of a radius d centered on a position 25 of the user 20 in plan view.

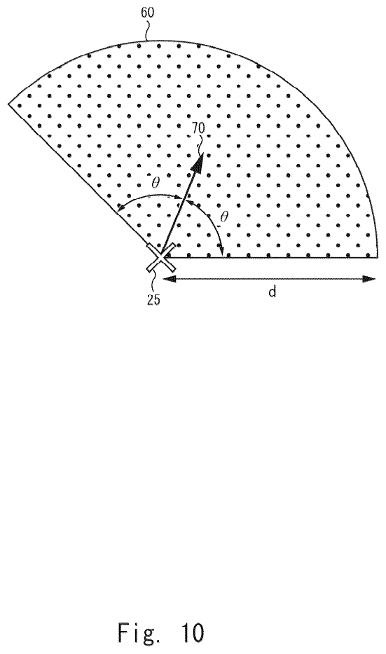

The detection range may be determined based on a direction (a line-of-sight direction or movement direction) of the user 20. For example, the detection range is determined in a range of a predetermined angle with the direction of the user 20 as a reference direction. FIG. 10 is a second diagram illustrating the detection range. In FIG. 10, the direction of the user 20 is indicated by an arrow 70. The detection range 60 is defined as a fan-shaped range having a radius of d and a range of ±θ° with respect to the direction of the user 20 in plan view.

As described above, by narrowing a range in which the obstacle 30 is detected with reference to the direction of the user 20, it is possible to reduce a time and computer resources required for the detection while detecting an object having a high probability of being an obstacle to the movement of the user 20.

Here, various technologies can be used as a technology for detecting the line-of-sight direction or the movement direction of the user 20. For example, the measurement direction of the sensor provided in the user terminal used by the user 20 can be determined, and the measurement direction can be treated as the line-of-sight direction or the movement direction of the user. Here, an existing technology can be used as a technology for determining the measurement direction based on the measurement data obtained from the sensor. In addition, for example, the movement direction of the user 20 may be determined from a temporal change of the position of the user 20 indicated by each of a plurality of pieces of position information 50 acquired so far.

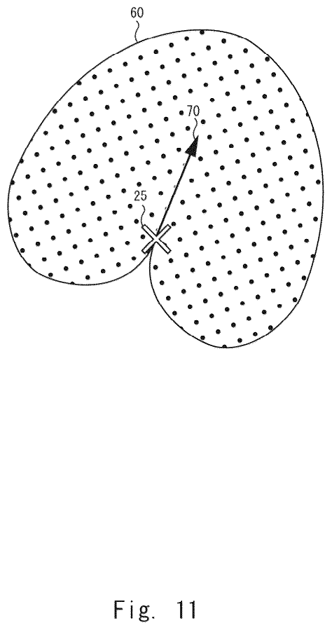

The detection range may be determined in such a way as to be wider in a region that is in a direction closer to the direction of the user 20. FIG. 11 is a third diagram illustrating the detection range. In the example of FIG. 11, a distance from the user 20 to a boundary of the detection range becomes longer in a direction closer to the direction of the user 20. In this way, the detection of the obstacle 30 can be performed in a wider range in a case where the range is a range in a direction in which the user 20 is more likely to move.

The detection range may be determined not only in a horizontal direction but also in the vertical direction. In addition, for example, the detection range determination unit 2100 may determine, as the detection range, a range above, below or both from the position of the user 20 within a predetermined distance from the position of the user 20. The predetermined distance may be the same or different between a range above the position of the user 20 and a range below the position of the user 20. In addition, for example, in a case where there is a plurality of floors in the facility 10, the detection range determination unit 2100 preferably determines a floor on which the user 20 is located and limits the detection range to only that floor.

### <Detection of Target Surface: S210>

The surface detection unit 2040 detects the target surface from the detection range 60 (S210). Specifically, the surface detection unit 2040 detects the target surface by using point data included in the detection range 60 among pieces of point data shown on the three-dimensional map 40. The method for detecting the target surface using the point data is as described in the first example embodiment.

### <Detection of Obstacle Region: S214 and S216>

The obstacle detection unit 2060 determines whether or not the obstacle condition is satisfied for each target surface detected in S210, and detects the target surface satisfying the obstacle condition as the obstacle region (S214 and S216). The method for detecting the target surface satisfying the obstacle condition as the obstacle region is as described in the first example embodiment.

### <Output of Detection Result>

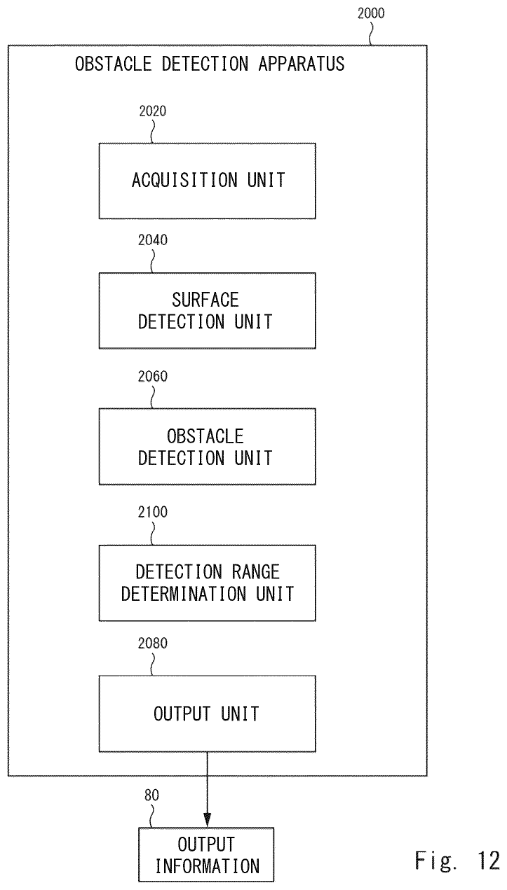

When the obstacle region is detected, the obstacle detection apparatus 2000 of the second example embodiment may output the output information 80 similarly to the obstacle detection apparatus 2000 of the first example embodiment. In this case, the obstacle detection apparatus 2000 of the second example embodiment includes the output unit 2080 described in the first example embodiment. FIG. 12 is a diagram illustrating a functional configuration of the obstacle detection apparatus 2000 of the second example embodiment including the output information 80.

Information indicated by the output information 80 of the second example embodiment varies. For example, the output information 80 of the second example embodiment indicates the type (a step, a device, a desk, a cable, or the like), size, position, or the like of the obstacle 30 indicated by the obstacle region, similarly to the output information 80 of the first example embodiment.

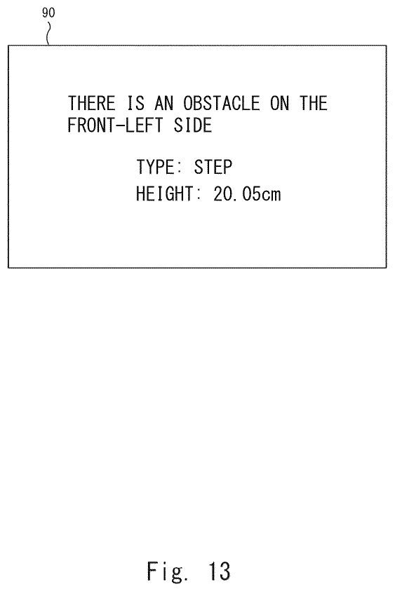

In addition, for example, the output information 80 may represent a warning for notifying the user 20 of the presence of the obstacle 30. In this case, the output information 80 preferably includes a message indicating the warning. FIG. 13 is a first diagram illustrating the output information 80. FIG. 13 illustrates a message 90 indicating a content of the output information 80. The message 90 indicates the position (diagonally front-left side) of the obstacle, the size (a height of about 20 cm) of the obstacle, and the type (step) of the obstacle. The message 90 is displayed, for example, on a display device of the user terminal possessed by the user 20.

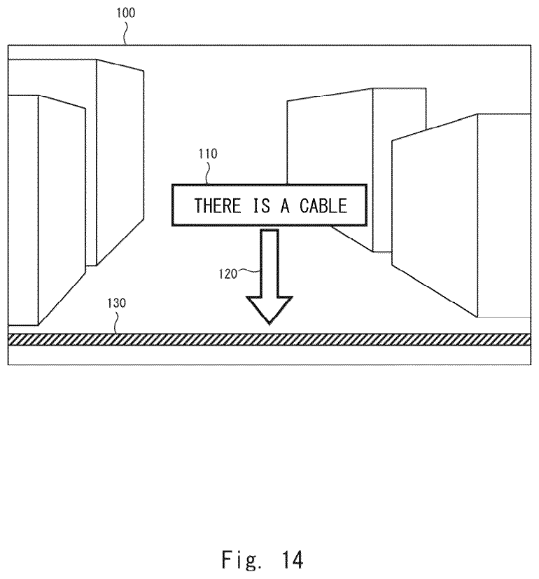

The output information 80 may further include a three-dimensional map of the periphery of the obstacle region. FIG. 14 is a second diagram illustrating the output information 80. FIG. 14 illustrates a screen 100 on which the content of the output information 80 is displayed. On the screen 100, a portion of the three-dimensional map 40 that is included in the field of view of the user 20 is displayed. In addition, an obstacle region 130 is highlighted on the screen 100. Specifically, the obstacle region 130 is hatched. Further, a message 110 for notifying that a cable is present as the obstacle 30 and an arrow 120 indicating a direction in which the obstacle 30 is located are displayed on the screen 100. The range of the three-dimensional map 40 displayed on the screen 100 is preferably changed in accordance with a change in the field of view of the user 20 (a change in position or direction of the user 20).

There are various methods for determining a portion of the three-dimensional map 40 that is included in the field of view of the user 20. For example, the output unit 2080 treats, as the portion included in the field of view of the user 20, a portion of the three-dimensional map 40 that is included in a predetermined range representing the field of view when the movement direction of the user 20 is viewed from the position of the user 20. In addition, for example, in a case where the user 20 uses a camera provided in the user terminal (hereinafter, referred to as a user camera), the output unit 2080 may treat, as the portion of the three-dimensional map 40 that is included in the field of view of the user 20, a capturing range of the user camera or a portion of the three-dimensional map 40 that is included in a predetermined range.

Here, it is assumed that a scene in a field-of-view direction of the user 20 is captured using the user camera. In this case, a video obtained from the user camera may be displayed on the screen 100 instead of the three-dimensional map 40. In this case, the output unit 2080 superimposes the various indicators illustrated in FIG. 14 on the video obtained from the user camera. Specifically, the output unit 2080 determines a region corresponding to the obstacle region detected from the detection range from the video, and highlights the region. In addition, the output unit 2080 superimposes the message 110 and the arrow 120 indicating the direction of the region corresponding to the obstacle region on the video of the user camera.

In addition, it is assumed that the user 20 wears a glasses-type device, and the spectacle type device is configured to display arbitrary information on a transmission type lens functioning as a display device so that the information can be superimposed on an actual scene seen through the lens. In this case, the output unit 2080 superimposes information regarding the obstacle 30 on a surrounding scene viewed by the user 20 through the glasses-type device. Specifically, the output unit 2080 determines a region corresponding to the obstacle region in a region of the lens, and displays an image (for example, an image of a specific color covering the obstacle region) indicating the obstacle region for the region. Further, the output unit 2080 displays the message 110 and the arrow 120 on the lens.

The output information 80 is not limited to visual information. For example, the output information 80 may be auditory information. That is, the output unit 2080 may output a message indicating a warning or a message indicating the position of an obstacle as a voice message. In this case, the user 20 can grasp the obstacle by listening to the voice message output from a speaker provided in the user terminal or the facility 10.

There are various manners of outputting the output information 80. For example, the output unit 2080 transmits the output information 80 to the user terminal. In addition, for example, the output unit 2080 may output the output information 80 to a storage unit accessible by the user terminal. In this case, the user terminal acquires the output information 80 by accessing the storage unit. In addition, for example, in a case where the output information 80 is a voice message, the output information 80 may be output to the speaker provided in the facility 10 to cause the speaker to output the voice message. Here, in a case where a plurality of speakers is provided in the facility 10, for example, the output unit 2080 preferably determines a speaker closest to the position of the user 20 and outputs the output information 80 to the speaker.

Although the present invention has been described above with reference to the example embodiments, the present invention is not limited to the above-described example embodiments. Various changes that can be understood by those skilled in the art can be made to the configurations and details of the present invention within the scope of the present invention.

In the above-described example, the program includes a group of commands (or software codes) for causing the computer to execute one or more functions described in the example embodiments, when read by the computer. The program may be stored in a non-transitory computer-readable medium or a tangible storage medium. As an example and not by way of limitation, the computer-readable medium or the tangible storage medium includes a random-access memory (RAM), a read-only memory (ROM), a flash memory, a solid-state drive (SSD) or any other memory technology, a CD-ROM, a digital versatile disc (DVD), a Blu-ray (registered trademark) disc or any other optical disk storage, a magnetic cassette, a magnetic tape, a magnetic disk storage, and any other magnetic storage device. The program may be transmitted on a transitory computer-readable medium or a communication medium. As an example and not by way of limitation, the transitory computer-readable medium or the communication medium includes electrical, optical, acoustic, or other forms of propagated signals.

Some or all of the above-described example embodiments can be described as in the following supplementary notes, but are not limited to the following supplementary notes.

### (Supplementary Note 1)

An obstacle detection apparatus comprising:

an acquisition unit configured to acquire a three-dimensional map representing a three-dimensional position of each of a plurality of points of a facility;

a surface detection unit configured to detect, from the three-dimensional map, a target surface for which determination of whether or not the target surface is an obstacle region is performed; and

an obstacle detection unit configured to detect, among the detected target surfaces, the target surface that satisfies a predetermined obstacle condition as the obstacle region,

wherein the obstacle condition includes an essential condition satisfied in a case where an angle formed by the target surface and a horizontal plane is equal to or larger than a first threshold.

### (Supplementary Note 2)

The obstacle detection apparatus according to supplementary note 1, wherein the obstacle condition further includes a condition that a height of the target surface from a floor surface is equal to or less than a second threshold.

### (Supplementary Note 3)

The obstacle detection apparatus according to supplementary note 1 or 2, wherein

the three-dimensional map includes, for each of the plurality of points of the facility, point data indicating a three-dimensional position of the point, and

the surface detection unit clusters the point data to generate a plurality of clusters, and detects, for each cluster, the target surface including the point data included in the cluster.

### (Supplementary Note 4)

The obstacle detection apparatus according to supplementary note 3, wherein the surface detection unit calculates a normal direction for each of a plurality of pieces of the point data, and includes a plurality of pieces of the point data whose differences among each other in normal direction are equal to or less than a threshold and whose distances among each other are equal to or less than a third threshold into the same cluster.

### (Supplementary Note 5)

The obstacle detection apparatus according to supplementary note 3 or 4, wherein the surface detection unit detects a plurality of pieces of the point data representing a cylindrical region by applying cylindrical fitting to the point data included in the three-dimensional map, and detects a side surface of a cylinder represented by the region as the target surface.

### (Supplementary Note 6)

The obstacle detection apparatus according to any one of supplementary notes 3 to 5, wherein

the surface detection unit

applying semantic segmentation to a plurality of pieces of the point data included in the three-dimensional map to divide into the clusters for each piece of the point data representing the same object, and

detects, for each of the clusters representing the same object, one or more target surfaces from the cluster.

### (Supplementary Note 7)

The obstacle detection apparatus according to supplementary note 6, wherein cylindrical fitting is performed on a plurality of pieces of the point data that is included into the cluster of a cylindrical object to detect a cylindrical region including the plurality of pieces of point data included in the cluster, and to detect a side surface of a cylinder represented by that region as the target surface.

### (Supplementary Note 8)

The obstacle detection apparatus according to any one of supplementary notes 1 to 7, wherein

the acquisition unit acquires position information indicating a position of a user,

the obstacle detection apparatus further comprises a detection range determination unit configured to determine a detection range as a detection target for the obstacle region from a region around the position of the user on the three-dimensional map by using the three-dimensional map and the position information, and

the surface detection unit detects the target surface from the detection range.

### (Supplementary Note 9)

The obstacle detection apparatus according to any one of supplementary notes 1 to 8, further comprising an output unit configured to output information indicating information regarding the detected obstacle region.

### (Supplementary Note 10)

The obstacle detection apparatus according to supplementary note 9, wherein the output information includes a screen that includes: an indicator that highlights the obstacle region; an indicator that indicates a position or a direction of the obstacle region; an indicator that indicates a type of an obstacle represented by the obstacle region; or two or more of the indicators.

### (Supplementary Note 11)

An obstacle detection method executed by a computer, the obstacle detection method comprising:

an acquisition step of acquiring a three-dimensional map representing a three-dimensional position of each of a plurality of points of a facility;

a surface detection step of detecting, from the three-dimensional map, a target surface for which determination of whether or not the target surface is an obstacle region is performed; and

an obstacle detection step of detecting, among the detected target surfaces, the target surface that satisfies a predetermined obstacle condition as the obstacle region,

wherein the obstacle condition includes an essential condition satisfied in a case where an angle formed by the target surface and a horizontal plane is equal to or larger than a first threshold.

### (Supplementary Note 12)

The obstacle detection method according to supplementary note 11, wherein the obstacle condition further includes a condition that a height of the target surface from a floor surface is equal to or less than a second threshold.

### (Supplementary Note 13)

The obstacle detection method according to supplementary note 11 or 12, wherein

the three-dimensional map includes, for each of the plurality of points of the facility, point data indicating a three-dimensional position of the point, and

in the surface detection step, clustering the point data to generate a plurality of clusters, and detecting, for each cluster, the target surface including the point data included in the cluster.

### (Supplementary Note 14)

The obstacle detection method according to supplementary note 13, wherein in the surface detection step, calculating a normal direction for each of a plurality of pieces of the point data, and including a plurality of pieces of the point data whose differences among each other in normal direction are equal to or less than a threshold and whose distances among each other are equal to or less than a third threshold into the same cluster.

### (Supplementary Note 15)

The obstacle detection method according to supplementary note 13 or 14, wherein in the surface detection step, detecting a plurality of pieces of the point data representing a cylindrical region by applying cylindrical fitting to the point data included in the three-dimensional map, and detecting a side surface of a cylinder represented by the region as the target surface.

### (Supplementary Note 16)

The obstacle detection method according to any one of supplementary notes 13 to 15, wherein

in the surface detection step,

applying semantic segmentation to a plurality of pieces of the point data included in the three-dimensional map to divide into the clusters for each piece of the point data representing the same object, and

detecting one or more target surfaces are detected for each of the clusters representing the same object from the cluster.

### (Supplementary Note 17)

The obstacle detection method according to supplementary note 16, wherein cylindrical fitting is performed on a plurality of pieces of the point data that is included into the cluster of a cylindrical object to detect a cylindrical region including the plurality of pieces of point data included in the cluster, and to detect a side surface of a cylinder represented by that region as the target surface.

### (Supplementary Note 18)

The obstacle detection method according to any one of supplementary notes 11 to 17, wherein

in the acquisition step, acquiring position information indicating a position of a user,

the obstacle detection method further comprises a detection range determination step of determining a detection range as a detection target for the obstacle region from a region around the position of the user on the three-dimensional map by using the three-dimensional map and the position information, and

in the surface detection step, detecting the target surface from the detection range.

### (Supplementary Note 19)

The obstacle detection method according to any one of supplementary notes 11 to 18, further comprising an output step of outputting output information indicating information regarding the detected obstacle region.

### (Supplementary Note 20)

The obstacle detection method according to supplementary note 19, wherein the output information includes a screen that includes: an indicator that highlights the obstacle region; an indicator that indicates a position or a direction of the obstacle region; an indicator that indicates a type of an obstacle represented by the obstacle region; or two or more of the indicators.

### (Supplementary Note 21)

A non-transitory computer-readable medium storing a program for causing a computer to execute:

an acquisition step of acquiring a three-dimensional map representing a three-dimensional position of each of a plurality of points of a facility;

a surface detection step of detecting, from the three-dimensional map, a target surface for which determination of whether or not the target surface is an obstacle region is performed; and

an obstacle detection step of detecting, among the detected target surfaces, the target surface that satisfies a predetermined obstacle condition as the obstacle region,

wherein the obstacle condition includes an essential condition satisfied in a case where an angle formed by the target surface and a horizontal plane is equal to or larger than a first threshold.

### (Supplementary Note 22)

The computer-readable medium according to supplementary note 21, wherein the obstacle condition further includes a condition that a height of the target surface from a floor surface is equal to or less than a second threshold.

### (Supplementary Note 23)

The computer-readable medium according to supplementary note 21 or 22, wherein

the three-dimensional map includes, for each of the plurality of points of the facility, point data indicating a three-dimensional position of the point, and

in the surface detection step, clustering the point data to generate a plurality of clusters, and detecting, for each cluster, the target surface including the point data included in the cluster.

### (Supplementary Note 24)

The computer-readable medium according to supplementary note 23, wherein in the surface detection step, calculating a normal direction for each of a plurality of pieces of the point data, and including a plurality of pieces of the point data whose differences among each other in normal direction are equal to or less than a threshold and whose distances among each other are equal to or less than a third threshold into the same cluster.

### (Supplementary Note 25)

The computer-readable medium according to supplementary note 23 or 24, wherein in the surface detection step, detecting a plurality of pieces of the point data representing a cylindrical region by applying cylindrical fitting to the point data included in the three-dimensional map, and detecting a side surface of a cylinder represented by the region as the target surface.

### (Supplementary Note 26)

The computer-readable medium according to any one of supplementary notes 23 to 25, wherein

in the surface detection step,

applying semantic segmentation to a plurality of pieces of the point data included in the three-dimensional map to divide into the clusters for each piece of the point data representing the same object, and

detecting one or more target surfaces are detected for each of the clusters representing the same object from the cluster.

### (Supplementary Note 27)

The computer-readable medium according to supplementary note 26, wherein cylindrical fitting is performed on a plurality of pieces of the point data that is included into the cluster of a cylindrical object to detect a cylindrical region including the plurality of pieces of point data included in the cluster, and to detect a side surface of a cylinder represented by that region as the target surface.

### (Supplementary Note 28)

The computer-readable medium according to any one of supplementary notes 21 to 27, wherein

in the acquisition step, acquiring position information indicating a position of a user,

the computer-readable medium further comprises a detection range determination step of determining a detection range as a detection target for the obstacle region from a region around the position of the user on the three-dimensional map by using the three-dimensional map and the position information, and

in the surface detection step, detecting the target surface from the detection range.

### (Supplementary Note 29)

The computer-readable medium according to any one of supplementary notes 21 to 28, further comprising an output step of outputting output information indicating information regarding the detected obstacle region.

### (Supplementary Note 30)

The computer-readable medium according to supplementary note 29, wherein the output information includes a screen that includes: an indicator that highlights the obstacle region; an indicator that indicates a position or a direction of the obstacle region; an indicator that indicates a type of an obstacle represented by the obstacle region; or two or more of the indicators.

### Reference Signs List

10 FACILITY
20 USER
25 POSITION
30 OBSTACLE
40 THREE-DIMENSIONAL MAP
50 POSITION INFORMATION
60 DETECTION RANGE
70 ARROW
80 OUTPUT INFORMATION
90 MESSAGE
100 SCREEN
110 MESSAGE
120 ARROW
130 OBSTACLE REGION
500 COMPUTER
502 BUS
504 PROCESSOR
506 MEMORY
508 STORAGE DEVICE
510 INPUT/OUTPUT INTERFACE
512 NETWORK INTERFACE
2000 OBSTACLE DETECTION APPARATUS
2020 ACQUISITION UNIT
2040 SURFACE DETECTION UNIT
2060 OBSTACLE DETECTION UNIT
2080 OUTPUT UNIT

What is claimed is:

1. An obstacle detection apparatus comprising:
at least one memory that is configured to store instructions; and
at least one processor that is configured to execute the instructions to:
acquire a three-dimensional map representing a three-dimensional position of each of a plurality of points of a facility;
detect, from the three-dimensional map, a target surface for which determination of whether or not the target surface is an obstacle region is performed; and
detect, among the detected target surfaces, the target surface that satisfies a predetermined obstacle condition as the obstacle region,
wherein the obstacle condition includes an essential condition satisfied in a case where an angle formed by the target surface and a horizontal plane is equal to or larger than a first threshold.

2. The obstacle detection apparatus according to claim 1, wherein the obstacle condition further includes a condition that a height of the target surface from a floor surface is equal to or less than a second threshold.

3. The obstacle detection apparatus according to claim 1, wherein
the three-dimensional map includes, for each of the plurality of points of the facility, point data indicating a three-dimensional position of the point, and
the detection of the target surface from the three-dimensional map includes:
clustering the point data to generate a plurality of clusters; and
detecting, for each cluster, the target surface including the point data included in the cluster.

4. The obstacle detection apparatus according to claim 3, wherein the detection of the target surface from the three-dimensional map includes:
calculating a normal direction for each of a plurality of pieces of the point data: and
including a plurality of pieces of the point data whose differences among each other in normal direction are equal to or less than a threshold and whose distances among each other are equal to or less than a third threshold into the same cluster.

5. The obstacle detection apparatus according to claim 3, wherein the detection of the target surface from the three-dimensional map includes:
detecting a plurality of pieces of the point data representing a cylindrical region by applying cylindrical fitting to the point data included in the three-dimensional map; and
detecting a side surface of a cylinder represented by the region as the target surface.

6. The obstacle detection apparatus according to claim 3, wherein the detection of the target surface from the three-dimensional map includes:
applying semantic segmentation to a plurality of pieces of the point data included in the three-dimensional map to divide into the clusters for each piece of the point data representing the same object; and
detecting, for each of the clusters representing the same object, one or more target surfaces from the cluster.

7. The obstacle detection apparatus according to claim 6, wherein cylindrical fitting is performed on a plurality of pieces of the point data that is included into the cluster of a cylindrical object to detect a cylindrical region including the plurality of pieces of point data included in the cluster, and to detect a side surface of a cylinder represented by that region as the target surface.

8. The obstacle detection apparatus according to claim 1, wherein the at least one processor is configured to execute the instructions further to:
acquire position information indicating a position of a user;
determine a detection range as a detection target for the obstacle region from a region around the position of the user on the three-dimensional map by using the three-dimensional map and the position information; and
the detection of the target surface from the three-dimensional map includes detecting the target surface from the detection range.

9. The obstacle detection apparatus according to claim 1, the at least one processor is configured to execute the instructions further to output information indicating information regarding the detected obstacle region.

10. The obstacle detection apparatus according to claim 9, wherein the output information includes a screen that includes: an indicator that highlights the obstacle region; an indicator that indicates a position or a direction of the obstacle region; an indicator that indicates a type of an obstacle represented by the obstacle region; or two or more of the indicators.

11. An obstacle detection method executed by a computer, the obstacle detection method comprising:
acquiring a three-dimensional map representing a three-dimensional position of each of a plurality of points of a facility;
detecting, from the three-dimensional map, a target surface for which determination of whether or not the target surface is an obstacle region is performed; and
detecting, among the detected target surfaces, the target surface that satisfies a predetermined obstacle condition as the obstacle region,
wherein the obstacle condition includes an essential condition satisfied in a case where an angle formed by the target surface and a horizontal plane is equal to or larger than a first threshold.

12. The obstacle detection method according to claim 11, wherein the obstacle condition further includes a condition that a height of the target surface from a floor surface is equal to or less than a second threshold.

13. The obstacle detection method according to claim 11, wherein
the three-dimensional map includes, for each of the plurality of points of the facility, point data indicating a three-dimensional position of the point, and
the detection of the target surface from the three-dimensional map includes clustering the point data to generate a plurality of clusters, and detecting, for each cluster, the target surface including the point data included in the cluster.

14. The obstacle detection method according to claim 13, wherein the detection of the target surface includes calculating a normal direction for each of a plurality of pieces of the point data, and including a plurality of pieces of the point data whose differences among each other in normal direction are equal to or less than a threshold and whose distances among each other are equal to or less than a third threshold into the same cluster.

15. The obstacle detection method according to claim 13, wherein the detection of the target surface from the three-dimensional map includes:
detecting a plurality of pieces of the point data representing a cylindrical region by applying cylindrical fitting to the point data included in the three-dimensional map; and
detecting a side surface of a cylinder represented by the region as the target surface.

16-20. (canceled)

21. A non-transitory computer-readable medium storing a program for causing a computer to execute:
acquiring a three-dimensional map representing a three-dimensional position of each of a plurality of points of a facility;
detecting, from the three-dimensional map, a target surface for which determination of whether or not the target surface is an obstacle region is performed; and
detecting, among the detected target surfaces, the target surface that satisfies a predetermined obstacle condition as the obstacle region,
wherein the obstacle condition includes an essential condition satisfied in a case where an angle formed by the target surface and a horizontal plane is equal to or larger than a first threshold.

22. The computer-readable medium according to claim 21, wherein the obstacle condition further includes a condition that a height of the target surface from a floor surface is equal to or less than a second threshold.

23. The computer-readable medium according to claim 21, wherein
the three-dimensional map includes, for each of the plurality of points of the facility, point data indicating a three-dimensional position of the point, and
the detection of the target surface from the three-dimensional map includes clustering the point data to generate a plurality of clusters, and detecting, for each cluster, the target surface including the point data included in the cluster.

24. The computer-readable medium according to claim 23, wherein the detection of the target surface from the three-dimensional map includes calculating a normal direction for each of a plurality of pieces of the point data, and including a plurality of pieces of the point data whose differences among each other in normal direction are equal to or less than a threshold and whose distances among each other are equal to or less than a third threshold into the same cluster.

25. The computer-readable medium according to claim 23, wherein the detection of the target surface from the three-dimensional map includes:
detecting a plurality of pieces of the point data representing a cylindrical region by applying cylindrical fitting to the point data included in the three-dimensional map; and
detecting a side surface of a cylinder represented by the region as the target surface.

26-30. (canceled)
